(19) United States
(12) Patent Application Publication
(10) Pub. No.: US 2016/0055733 A1
(43) Pub. Date: Feb. 25, 2016

(54) SPRAYING MONITORING SYSTEM

(71) Applicant: Gary Zhang, Calgary (CA)

(72) Inventor: Gary Zhang, Calgary (CA)

(21) Appl. No.: 14/466,323

(22) Filed: Aug. 22, 2014

(51) Int. Cl. G08B 21/18; H04W 4/02; G01S 19/01

(52) U.S. Cl. CPC G08B 21/18; G01S 19/01; H04W 4/02

(57) ABSTRACT

An apparatus and method for monitoring the application of substances from a dispenser. The apparatus comprising a sensor adapted to detect when a substance is being dispensed from the dispenser and a transmitter in communication with the sensor adapted to transmit a signal in response to the sensor detecting a substance is being dispensed. The apparatus also includes a gps sensor adapted to determine a location, a memory and a processor circuit operable to receive the signal and the location from the gps and send information relating to the locations where the substance has been dispensed to the memory. The method comprises sensing when a substance is being dispensed therefrom through the dispenser, transmitting a signal to a processor circuit in response to the sensing, receiving at a processor circuit the signal and an input representing location and providing a dispensing location to a database.

### BACKGROUND OF THE INVENTION

1. Field of Invention

The present invention relates to the field of pesticide and herbicide application in general and in particular to a method for determining and monitoring the location of the application of such substances.

2. Description of Related Art

In the industry of herbicide or pesticide application, one common application method is to provide an operator with a truck or backpack mounted spraying unit containing a quantity of the herbicide or pesticide. Thereafter the operator may drive or be otherwise transported to the location where the pesticide or herbicide is desired to apply the herbicide or pesticide in a known method. Commonly such truck or backpack mounted devices include a wand or spray gun through which the herbicide or pesticide must be applied.

One difficulty with herbicide and pesticide application is that too frequent or infrequent applications to a desired location will compromise the desired effect of the herbicide or pesticide. Currently however, there is not a rapid and reliable method of monitoring the application of such herbicides or pesticides to a given location to prevent such under or over application. An additional difficulty is that it is often difficult for an operator to know if the location where they intend to spray has already been sprayed or if such a location is undesirable of having herbicide or pesticide located there.

### SUMMARY OF THE INVENTION

According to a first embodiment of the present invention there is disclosed an apparatus for monitoring the application of substances from a dispenser comprising a sensor adapted to detect when a substance is being dispensed from the dispenser and a transmitter in communication with the sensor adapted to transmit a signal in response to the sensor detecting a substance is being dispensed. The apparatus also includes a gps sensor adapted to determine a location, a memory and a processor circuit operable to receive the signal and the location from the gps and send information relating to the locations where the substance has been dispensed to the memory.

The processor circuit and the gps sensor may be located within a mobile device. The memory may be associated with the mobile device. The memory may be located remotely from the mobile device. The processor circuit and the memory may communicate over a network.

The processor circuit may be adapted to look up a location in the memory. The processor circuit may be adapted to provide an indication to the user if a current location has been designated to not have the substances dispensed thereat. The indication may comprise an alarm.

The sensor may be applied to an actuator of the dispenser to determine when the actuator has been depressed. The sensor may comprise a proximity sensor adapted to sense when a trigger has been depressed. The sensor may comprise a magnetic sensor.

According to a further embodiment of the present invention there is disclosed a method for monitoring the application of substances from a dispenser comprising sensing when a substance is being dispensed therefrom through the dispenser, transmitting a signal to a processor circuit in response to the sensing, receiving at a processor circuit the signal and an input representing location and providing a dispensing location to a database.

The method may further comprise, using the processor circuit, looking up a location in the database to determine a location has been designated to not have the substances dispensed thereat. The step of providing a dispensing location to a database may be performed within a mobile device wherein the processor and the database are located within the mobile device. The step of providing a dispensing location to a database may be performed across a network. The network may comprise a wireless network.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention wherein similar characters of reference denote corresponding parts in each view,

FIG. 1 is an illustration of a system for monitoring the application of substances from a portable dispenser according to a first embodiment of the present invention.

FIG. 2 is an illustration of a spray gun for use in the system of FIG. 1.

FIG. 3 is a block diagram of one mobile interface device of the system of FIG. 1.

FIG. 4 is a flow chart of the method for use in the system of FIG. 1.

FIG. 5 is an illustration of a mobile interface device showing a map for use in the system of FIG. 1

### DETAILED DESCRIPTION

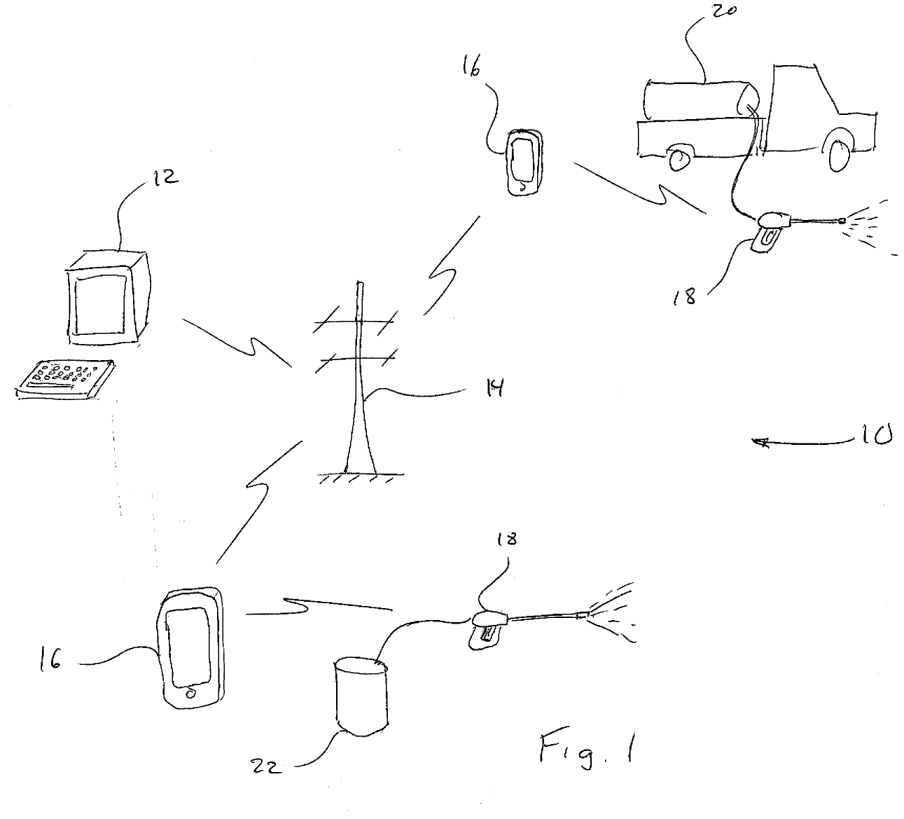

Referring to FIG. 1, a system for monitoring and providing herbicide and pesticide spray information to an operator is shown generally at 10. The system comprises a database 12, a communication network, represented generally at 14 and a mobile interface device 16 in communication with a sensor mounted on a sprayer 18 as will be more fully described below. As illustrated in FIG. 1, the sprayer may be supplied with a herbicide or pesticide from either a truck mounted or a back mounted tank, 20 or 22, respectively. The mobile interface device 16 may comprise a computer, smart phone, tablet or the like. The network 14 may be a wireless (cellular, satellite, microwave, infrared, radio, etc.) network, local network, wide-area network, the Internet, or any other suitable communication network or networks, and may be implemented on any suitable platform including wired and/or wireless networks. As will be more fully described below the sensor on the sprayer 18 determines when the sprayer is dispensing a herbicide or pesticide and thereafter transmits this information to the mobile interface device for recording in internal or remote memory to track the locations of the spraying.

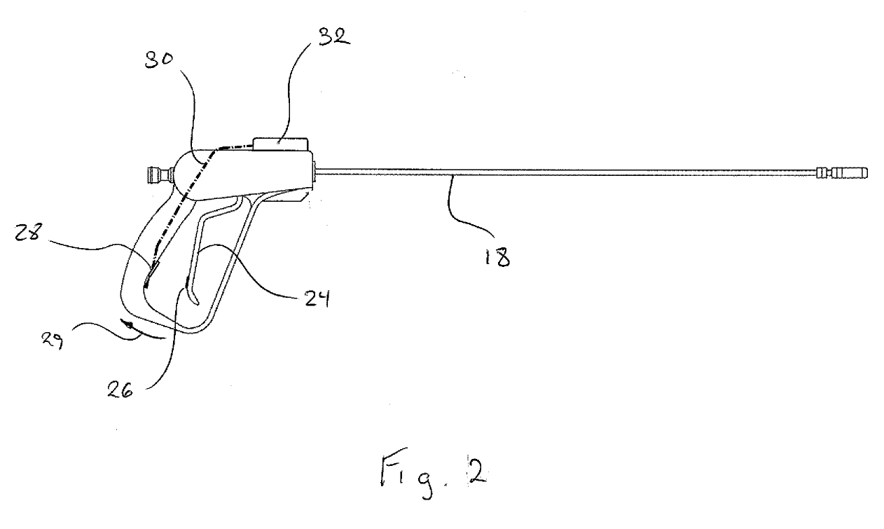

Turning now to FIG. 2, an illustration of the sprayer 18 is provided which may be of any conventional type. The sprayer 18 may include a trigger 24 as are commonly known with a magnet 26 mounted to the trigger and a magnetic sensor 28 secured to a handle of the sprayer 18 so as to sense when the trigger is depressed in a direction generally indicated at 29 thereby bringing the magnet 26 into proximity to the sensor 28. The magnet 26 and the sensor 28 may also optionally be built into the sprayer 18. The sprayer 18 also includes a transmitter 32 in communication with the sensor 28 through a wire 30 or optionally a wireless connection. It will also be appreciated that the transmitter 32 and sensor 28 may be formed within the same unitary body or as a single article.

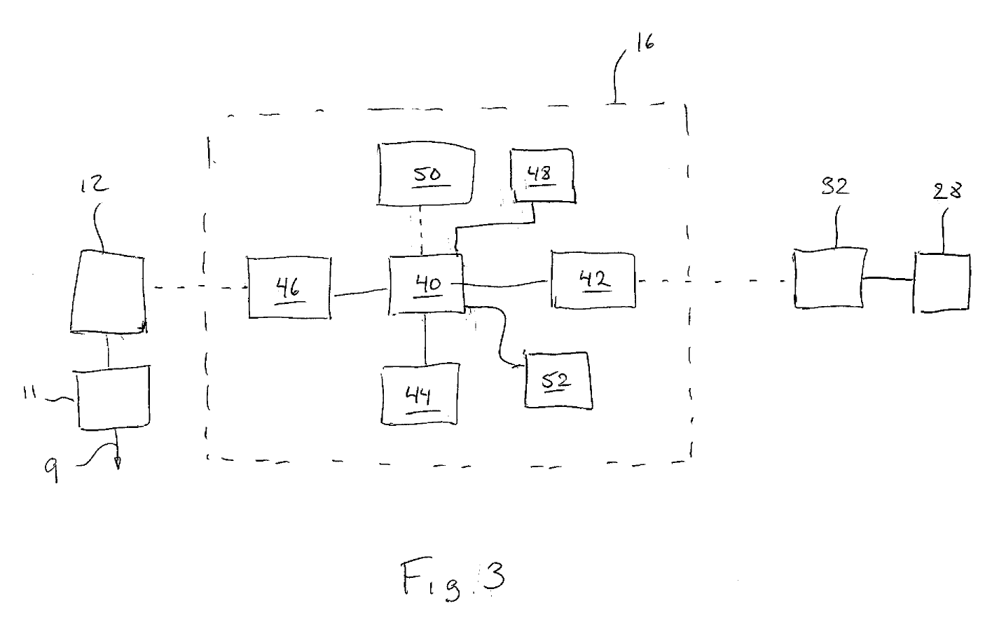

Referring to FIG. 3, the mobile interface device 16 of the system 10 is illustrated. The mobile interface device 16 includes a processor circuit 40, a receiver 42, a display screen 44, power supply 48, and a transmitter 46 and optionally a memory 50. The mobile interface device 16 also includes a global positioning (GPS) sensor 52. The receiver 42 is adapted to receive a signal from the sprayer transmitter 32 indicating when the sprayer trigger 24 has been depressed thereby dispensing herbicides or pesticides therethrough. The receiver then transmits this signal to the processor circuit 40 which also looks up a location utilizing the GPS sensor 52. The processor circuit 40 transmits the location of the spray to the database 12 through the transmitter. Optionally, the processor circuit 40 may store this information within the memory 50 on the mobile interface device.

In the present embodiment, the processor circuit includes a microprocessor or other suitable processor circuit as are generally known in the art. More generally, in this specification, including the claims, the term “processor circuit” is intended to broadly encompass any type of device or combination of devices capable of performing the functions described herein, including (without limitation) other types of microprocessors, microcontrollers, other integrated circuits, other types of circuits or combinations of circuits, logic gates or gate arrays, or programmable devices of any sort, for example, either alone or in combination with other such devices located at the same location or remotely from each other, for example. Additional types of processor circuits will be apparent to those ordinarily skilled in the art upon review of this specification, and substitution of any such other types of processor circuits is considered not to depart from the scope of the present invention as defined by the claims appended hereto.

It will be appreciated that many types of databases or memory devices 12 and 50 may be utilized to perform the functions associated with the various routines described herein. Alternatively, such routines may be provided as software stored on a different medium such as random access memories (RAMs), programmable read-only memories such as EPROMs, EEPROMs or FLASH memories, for example, or any other type of memory device, either at the location of the processor circuit or located remotely therefrom, may be substituted if desired. It will also be appreciated that the functions of the processor circuit 40 and memory 50 may be provided by an application specific logic array designed to provide the functions as set out below, such as by way of non-limiting example an application specific integrated circuit.

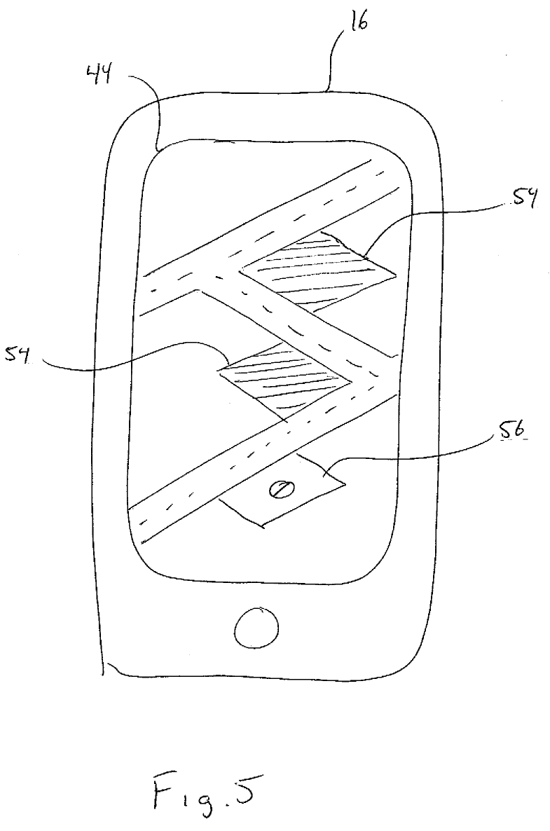

Optionally, the mobile interface device 16 may be configured to display to a user where previous sprays have occurred. With reference to FIG. 5, optionally, the display screen 44 of the mobile interface device 16 may be configured to display a map showing regions which have previously had herbicides or pesticides sprayed thereon generally indicated at 54 or regions in which spraying is prohibited generally indicated at 56. Optionally, the mobile interface device may be configured to output an alarm or other signal upon receiving a spray activation signal when located within one of the previous spray or prohibited regions 54 or 56.

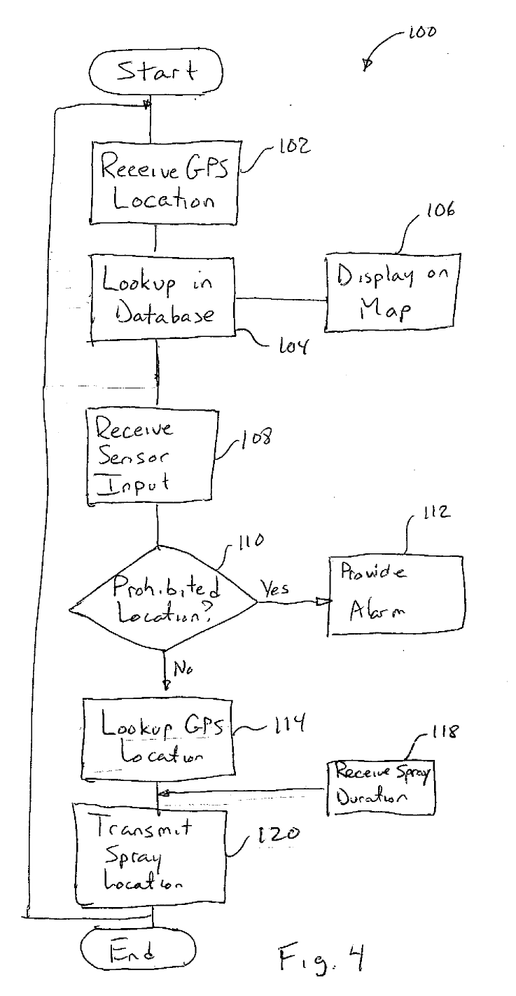

FIG. 4 is a flowchart depicting the method 100 taken by the processor circuit 40 of the mobile interface device 16. In step 102, the processor 5 circuit 40 receives a location from the GPS sensor 52. The processor circuit 40 then looks up this location in the database 12 or the memory 50 in step 104 and optionally outputs a map to indicate regions of prohibited spraying or previous application as set out above in step 106.

When the mobile interface device 16 receives an input indicating that the trigger 24 has been depressed as described above and shown in step 108, the processor circuit then compares the current location to determine if this location is prohibited or previously applied with the herbicide or pesticide from the database in step 110. If this location has been designated as prohibited or previously sprayed then an alarm may be provided in step 112. It will be appreciated that this alarm may be of any suitable type, such as, visual, auditory, a vibration from the mobile interface device, or any other suitable indication to the operator that spraying should not continue at this location.

If the location is not prohibited, then in step 120, the mobile interface device 16 provides the location of the spray to the database or memory 12 or 50. Optionally, the mobile interface device 16 may again look up the GPS location with the GPS sensor in step 114 and may also optionally track the duration of the spray with a timer in step 118 before transmitting the spray information to the database. The transmitted data to the database may comprise merely the location where a spray has occurred, or may optionally continuously transmit all the GPS locations where sprays have occurred to be compiled in the database. Optionally, the data transmitted to the database may comprise the location, time and duration of the spray after the spray has completed. After the spray data is transmitted to the database, the system may repeat the above steps for subsequent sprays.

According to a further embodiment, the database may include a processor circuit 11 adapted to output data, generally indicated at 9 for use by an operator. Examples of the data which may be outputted by the processor circuit 11 may comprise summaries or reports of the applied pesticides or herbicides as well as provide invoices or billing information for locations, quantities or areas treated.

While specific embodiments of the invention have been described and illustrated, such embodiments should be considered illustrative of the invention only and not as limiting the invention as construed in accordance with the accompanying claims.

What is claimed is:

1. An apparatus for monitoring the application of substances from a dispenser, the apparatus comprising:
a sensor adapted to detect when a substance is being dispensed from the dispenser;
a transmitter in communication with said sensor adapted to transmit a signal in response to said sensor detecting a substance is being dispensed;
a gps sensor adapted to determine a location;
a memory; and
a processor circuit operable to receive said signal and said location from said gps and send information relating to said locations where said substance has been dispensed to said memory.

2. The apparatus of claim 1 wherein said processor circuit and said gps sensor are located within a mobile device.

3. The apparatus of claim 2 wherein said memory is associated with said mobile device.

4. The apparatus of claim 1 wherein said memory is located remotely from said mobile device.

5. The apparatus of claim 4 wherein said processor circuit and said memory communicate over a network.

6. The apparatus of claim 1 wherein said processor circuit is adapted to look up a location in said memory.

7. The apparatus of claim 6 wherein said processor circuit is adapted to provide an indication to said user if a current location has been designated to not have said substances dispensed thereat.

8. The apparatus of claim 7 wherein said indication comprises an alarm.

9. The apparatus of claim 1 wherein said sensor is applied to an actuator of said dispenser to determine when said actuator has been depressed.

10. The apparatus of claim 9 wherein said sensor comprises a proximity sensor adapted to sense when a trigger has been depressed.

11. The apparatus of claim 10 wherein said sensor comprises a magnetic sensor.

12. A method for monitoring the application of substances from a dispenser comprising:
sensing when a substance is being dispensed therefrom through the dispenser;
transmitting a signal to a processor circuit in response to said sensing,
receiving at a processor circuit said signal and an input representing location; and
providing a dispensing location to a database.

13. The method of claim 12 further comprising, using said processor circuit, looking up a location in said database to determine a location has been designated to not have said substances dispensed thereat.

14. The method of claim 12 wherein said providing a dispensing location to a database is performed within a mobile device wherein said processor and said database are located within said mobile device.

15. The method of claim 12 wherein said providing a dispensing location to a database is performed across a network.

16. The method of claim 15 wherein said network comprises a wireless network.
